(19) United States
(12) Patent Application Publication
(10) Pub. No.: US 2001/0049821 A1
(43) Pub. Date: Dec. 6, 2001

(54) Network-utilizing content broadcast system and contest execution system

(76) Inventor: Yasushi Ochi, Osaka (JP)

Correspondence Address: SHINJYU GLOBAL IP COUNSELORS, LLP, 1233 20TH STREET, NW, SUITE 700, WASHINGTON, DC, 20036-2680, US

(21) Appl. No.: 09/852,320

(22) Filed: May 11, 2001

(30) Foreign Application Priority Data
Jun. 2, 2000 (JP) 2000-166724

(51) Int. Cl. H04N 7/16

(52) U.S. Cl. 725/32; 725/36; 725/1

(57) ABSTRACT

Content broadcast system enabling broadcast content and advertising data to be solicited at low cost, and enabling providers readily to offer content they create. The content broadcast system is configured with a central processing device (10) and a plurality of terminal devices connected via a network (2) for broadcasting content from the central processing device (10) to the terminal devices. The central processing device (10) is configured with: a content-accepting module (14) that accepts content from the terminal devices; a content memory (21) in which accepted content is stored; an ad-accepting module (15) that accepts advertising data from the terminal devices; an ad data memory (22) in which accepted advertising data is stored; a Net publishing module (13) that publishes information relating to content stored in the content memory (21), together with advertising data stored in the ad data memory (22); and a content broadcast module (16) that accepts content broadcast requests from the terminal devices and broadcasts requested content to the terminal devices where there have been broadcast requests.

### BACKGROUND OF THE INVENTION

1. Technical Field

The present invention relates to systems configured for broadcasting content of various kinds via a network such as the Internet to user-end installed computer terminal devices.

2. Description of Related Art

Note that “broadcast” as used herein signifies, as defined for example in Newton's Telecom Dictionary, (Harry Newton, 1998, Flatiron Publishing New York, N.Y.): “To send information to two or more receiving devices simultaneously-over a data communications network.” This is in contrast with, for example, “unicast,” defined ibid. as “The communication from one device to another device over a network. In other words, a point-to-point communication.”

As systems for broadcasting via networks text, voice and image information/data, and computer/software content, conventionally known are broadcast systems in which a Web Page is set up on the Internet, and downloading of specified or user-selected content to the terminal device through which a user has accessed the Web Page is enabled. Furthermore, configurations for posting prescribed advertisements on the Web Pages have been known conventionally.

In this regard, the above-described content and advertisements posted on Web Pages have heretofore been gathered by soliciting at large through ways apart from networks, for example print media and direct business contacts.

Nevertheless, the expected costs for gathering content and advertisements recruited as noted above through print media and direct business contacts are remarkably expensive. Fees for running influential ads, and content broadcasting fees are therefore high, and place a large burden on the advertising providers (sponsors) and system users, which expectedly leads to tie-ups in utilization of the systems themselves. Furthermore, to provide content they created themselves, content providers have only been able to go through the various print media routes, in which responding to solicitations is extremely limited.

### BRIEF SUMMARY OF THE INVENTION

In view of the foregoing actual situation, an object of the present invention is to provide a content broadcast system, and a contest execution system employing the content broadcast system, that enable low-cost solicitation of broadcast content and advertising data, and that enable content providers readily to provide content they have created.

To resolve the foregoing issues, the present invention in first aspect is a content broadcasting system being connected via a network to a central processing device and a plurality of terminal devices, the content broadcasting system configured for broadcasting content from the central processing device to the terminal devices, and characterized in that the central processing device is configured by comprising: a content-accepting module for accepting offers of content from the terminal devices; a content memory for storing accepted content; an ad-accepting module for accepting advertising data from the terminal devices; an ad data memory for storing advertising data accepted by the ad-accepting module; a network publishing module for publishing information related to the content stored in the content memory, together with advertising data stored in the ad data memory; and a content broadcast module for accepting content broadcast requests from the terminal devices and broadcasting requested content to the terminal devices where there have been broadcast requests.

In the invention thus, a content accepting module in a central processing device connected to a network such as the Internet accepts text, voice and image information/data, and computer/software content, provided, or in other words uploaded, through the terminal devices likewise connected to the network, and the accepted content is stored in a content memory. Meanwhile advertising data likewise provided through the terminal devices is accepted by an ad-accepting module, and the accepted advertising data is stored in an ad data memory. These processes for accepting content and advertising data are carried out, for example, via Web Pages published on the Internet.

The Net publishing module publishes information relating to content items stored in the content memory, and advertising data stored in the ad data memory, on the Net via, for example, a Web Page put on view for users who have accessed it through the terminal devices. Then when there are content broadcast requests through terminal devices of users who have made perusal, the content broadcast module having accepted these requests transmits the requested content to the given users' terminal devices.

In this way the present invention makes it so that content for broadcast and advertising for Web-Page postings are solicited via a network, and therefore enables the content and advertising to be gathered at low cost. The invention furthermore makes it easy for content providers to provide content they have created.

Also, in the above-noted broadcasting of content, the present invention, as in a second aspect, may be made establishing a broadcast fee billing module so that wherein the content broadcast module has broadcast content to the terminal devices where there have been broadcast requests, the broadcast requesters are charged a pre-set broadcast fee.

Further, the present invention in third aspect is a content broadcasting system being connected via a network to a central processing device and a plurality of terminal devices, the content broadcasting system configured for broadcasting content from the central processing device to the terminal devices, and characterized in that the central processing device is configured by comprising: a content-accepting module for accepting offers of content from the terminal devices; a content memory for storing accepted content; a network publishing module for publishing information related to the content stored in said content memory; an ad-accepting module for, in broadcasting the content, accepting from the terminal devices advertising data to be attached to content that is broadcast; an ad data memory for storing correlatively with corresponding content, advertising data accepted by said ad-accepting module; a content broadcast module for accepting content broadcast requests from the terminal devices and broadcasting to the terminal devices where there have been broadcast requests requested content together with the advertising data to be attached to content.

By the present invention, likewise as with the above-described first aspect, content provided (uploaded) through the terminal devices is accepted by the content accepting module and stored in the in the content memory; information on the content items stored in the content memory is published on the Net by the Net publishing module and put on view for content users and advertising providers who have accessed the information through the terminal devices.

Then, when an advertising provider who has perused the just-noted content information applies to have advertising posted, advertising data provided from the advertising provider is accepted by the ad-accepting module together with content information to which the advertising data is to be attached. The advertising data and content information are mutually correlated and stored in the ad data memory.

Meanwhile, when a content user who has perused the content information mentioned above makes a content broadcast request, the content broadcast module having accepted the request transmits to the given user's terminal device the requested content together with the advertising data that is for attachment thereto.

In this way the present invention makes it so that content for broadcast and advertising data are solicited via a network, and likewise as in the first aspect of the present invention, therefore enables the content and the advertising data to be gathered at low cost, and facilitates provision by content providers of content they have created. Moreover, by perusing the content information, the advertising providers may study to which content items, upon checking overviews thereof, their advertising should be attached. For example, taking into consideration users' age brackets assumed from the genre to which the content belongs and attaching advertising data to the most effective content would get the given users to view the advertising data. Also, the advertising providers in the foregoing manner can select at will content to which advertising data is to be attached. Further possible is having the advertising data attached to all content that is broadcast.

Also, in the above-noted broadcasting of content, the content broadcast module may be configured so as, in response to requests from the terminal devices, to attach advertising selectively to content—i.e., to attach advertising data to content only in instances in which broadcast requesters have permitted attachment of advertising-and broadcast it to the terminal devices where there have been broadcast requests, as in a fourth aspect of the present invention.

Further, herein, as in a fifth aspect of the present invention, the content broadcasting system, by setting it up with a broadcast fee billing module, may be configured so as to charge broadcast requesters a pre-set broadcast fee in instances in which the content broadcast module has broadcast content to the terminal devices where there have been broadcast requests, without attaching advertising data. Here, the billing method presumably may be a method in which credit is used.

Also, in a sixth aspect of the present invention, applicable to any of the above-described third through fifth aspects, the network publishing module is configured to publish overview information relating to content stored in the content memory, and meanwhile to broadcast in response to requests from the terminal devices detailed information relating to content stored in the content memory; at the same time is configured to count per content item number of times detailed information on content items has been accessed through the terminal devices; and further is configured to publish the access count together with the overview information.

This means that with present invention the number of times there has been access through the terminal devices to detailed information on the content items is counted for each of the content items by the Net publishing module, and the counted access count is published together with the overview information. Therefore, by looking through the content information as noted above and upon reviewing a summary thereof together with the status of content-user access, advertising providers may study to which content items their advertising should be attached. Accordingly this enables advertising providers to conduct their advertising more effectively.

Here, the present invention, as in a seventh aspect thereof, may be established with an ad fee computing module so as to compute an advertising fee according to the access count, based on the number of times the detailed information on the content items is accessed, counted by the network publishing module. Doing so enables advertising fees to be established according to advertising effectiveness.

Also, in an eighth aspect of the present invention, applicable to any of the above-described third through seventh aspects, the content broadcast module is configured so as to count the number of times each content item is broadcast to the terminal devices; and the network publishing module is configured so as to publish the broadcast count counted by the content broadcast module.

This means that with present invention the number of times each of the content items has been broadcast to the terminal devices is counted, and the counted broadcast count is published. Therefore, upon checking the count of broadcasts to content users, advertising providers may investigate to which content items their advertising should be attached. Likewise as with the foregoing sixth aspect of the invention, this enables advertising providers to conduct their advertising more effectively.

Here, the present invention, as in a ninth aspect thereof, may be established with an ad fee computing module so as to compute an advertising fee according to the broadcast count, based on the number of times the content items are broadcast, counted by the content broadcast module. Doing so enables advertising fees to be established according to advertising effectiveness.

Further, in a tenth aspect of the present invention, applicable to any of the above-mentioned third through ninth aspects, the content broadcasting system is further provided with a content rating module for accepting rating information relating to content received from the terminal devices having received broadcast of content, and carrying out a content rating process on each content item by tallying the accepted rating information; wherein the network publishing module is configured so as to publish results of ratings by the content rating module.

This means that with present invention rating information on given content is accepted from content users who have received content broadcasts, rating of the given content is performed based on this rating information, and the results are published. Therefore from particular rating results advertising providers may estimate future extent of access and quantity of broadcasts with respect to given content, and based on the estimates thus made, select content through which advertising will be highly effective. Accordingly, advertising providers have their advertising attached to content selected in this way, which enables them to conduct their advertising more effectively.

Here, the present invention, as in an eleventh aspect thereof, may be established with an ad fee computing module so as to compute, based on the results of ratings by the content rating module, an advertising fee according to the rating results. Doing so enables advertising fees to be established according to estimated advertising effectiveness.

Further, in the present invention set forth in the above-described seventh, ninth, or eleventh aspects, an ad fee billing process module may be established so as to charge advertising applicants advertising fees computed by the ad fee computing module. Here, the billing method presumably may be a method in which credit is used.

The present invention in thirteenth aspect is a contest execution system being connected via a network to a central processing device and a plurality of terminal devices, the contest execution system configured for broadcasting content from the central processing device to the terminal devices and configured so as to set up contests utilizing the content in the central processing device, and characterized in that the central processing device is configured by comprising: a content-accepting module for accepting offers of content (uploaded) from the terminal devices; a content memory for storing accepted content; an ad-accepting module for accepting advertising data from the terminal devices; an ad data memory for storing advertising data accepted by the ad-accepting module; a network publishing module for publishing, together with advertising data stored in the ad data memory, contest proposal material utilizing the content stored in the content memory; a participation-accepting module for accepting applications from the terminal devices to participate in contests, and broadcasting content to terminal devices where there have been applications; a contest-held results accepting module for accepting from the terminal devices results of contests executed utilizing the content; and a contest-tallying module for tallying contest-held results accepted by the contest-held results accepting module and thereby assigning contest participant rankings.

The present invention, likewise as with the above-described first and third aspects, makes it so that content for broadcast and advertising data are solicited via a network, and therefore enables the content and advertising to be gathered at low cost. The invention furthermore facilitates content providers' providing content they have created.

Thus, contests are established utilizing enlisted content, the subject matter of the contests is published together with advertising data, and participation in given contests is accepted. Given content is broadcast by the participation-accepting module to persons who have made application to participate; the participants hold a competition utilizing the given content. Contest-held results are transmitted from the terminal devices that the participants use to the contest-held results accepting module. And the contest-held results are tallied by the contest-tallying module, on the basis of which result participant rankings are assigned. Accordingly, with the present invention competitive matches can be set up by a heretofore completely non-existent technique that makes holding contests on the Net utilizing enlisted content possible. Further, the content providers are given the incentive that content they created is used in the contests, which succeeds in the effect that content the content providers create more enterprisingly themselves is provided.

Here, the advertising data can, as in a fourteenth aspect of the present invention, be broadcast by the participation-accepting module together with the content to terminal devices where there have been participation applications. In doing so, advertising providers can conduct their advertising more effectively.

Further, the present invention in fifteenth aspect is a contest execution system being connected via a network to a central processing device and a plurality of terminal devices, configured for broadcasting content from the central processing device to the terminal devices and configured so as to set up contests utilizing the content in the central processing device, and characterized in that the central processing device is configured by comprising: a content-accepting module for accepting offers of content (uploaded) from the terminal devices; a content memory for storing accepted content; an ad-accepting module for accepting advertising data from the terminal devices; an ad data memory for storing advertising data accepted by the ad-accepting module; a network publishing module for publishing contest proposal material utilizing the content stored in the content memory; a participation-accepting module for accepting applications from the terminal devices to participate in contests, and broadcasting the content to terminal devices where there have been applications, together with advertising data stored in the ad data memory; a contest-held results accepting module for accepting from the terminal devices results of contests executed utilizing the content; and a contest-tallying module for tallying contest-held results accepted by the contest-held results accepting module and thereby assigning contest participant rankings. This aspect of the invention also succeeds in effects likewise as with the invention in the foregoing thirteenth and fourteenth aspects.

Further, in a sixteenth aspect of the present invention, applicable to the above-noted thirteenth through fifteenth aspects, the participation-accepting module is configured so as to count participation applicant number; and the network publishing module is configured so as to publish the participation applicant count counted by said participation-accepting module. According to this aspect of the invention, being able to check counts of participants in the contests, the advertising providers can readily predict the effectiveness of advertisement postings by way of given contests, enabling them readily to perform judgments as to whether advertising should be posted.

Further, the present invention in a seventeenth aspect, applicable to the above-noted thirteenth through sixteenth aspects, is furnished with a proposal accepting module for accepting from the terminal devices contest proposals utilizing content stored in the content memory; the network publishing module being configured so as to publish proposal material accepted by the proposal accepting module, together with the advertising data stored in the ad data memory. By this aspect of the invention, proposed material for contests is invited from the public at large including content providers, advertising providers (advertising sponsors), and contest participants, and contests are set up based on the enlisted proposals. This accordingly yields the benefit for the content providers of establishing contests in which content concepts they themselves intended are sufficiently put to use. Furthermore, it yields the benefit for the advertising providers of being able to advertise more effectively, by setting up contests that can rally participants focussed into customer strata the advertising providers target.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is an explanatory diagram showing a configurational outline of a broadcast system according to one embodiment of the present invention;

FIG. 2 is a block diagram showing a configurational outline of a central processing device according to a first embodiment of the present invention;

FIG. 3 through 7 are explanatory diagrams illustrating content of processes in the central processing device according to the first embodiment of the present invention;

FIG. 8 is a block diagram showing a configurational outline of a central processing device according to a second embodiment of the present invention;

FIG. 9 is a block diagram showing a configurational outline of a central processing device in connection with a more specifically applied example in the second embodiment; and

FIG. 10 is a block diagram showing a configurational outline of a central processing device in connection with a modified example in the second embodiment.

### DETAILED DESCRIPTION OF THE PREFERRED EMBODIMENTS

Based on the attached drawings, explanation of specific embodiments of the present invention follows.

### First Embodiment

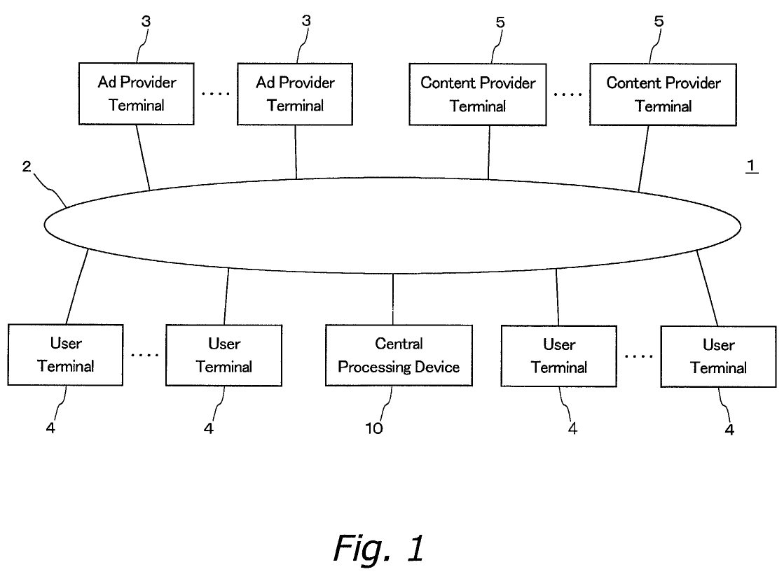

To begin, a first embodiment of the present invention will be explained. FIG. 1 is an explanatory diagram showing a configurational outline of a broadcast system according to the present embodiment.

As shown in the above-noted FIG. 1, the broadcast system in this example is provided with: advertising provider terminal devices (terminals) 3 interconnected via a network 2 such as the Internet, user terminal devices (terminals) 4, content provider terminal devices (terminals) 5, and a central processing device 10. The central processing device 10 functions as an Internet server such as a WWW (World Wide Web) server, and as a server equipped with a CGI (Common Gateway Interface) script. The advertising provider terminals 3, the user terminals 4, and the content provider terminals 5 function as clients respectively furnished with browsers. Note that the advertising provider terminals 3 are terminals that advertising providers (advertising sponsors) who wish to run advertisements use; the user terminals 4 are terminals that persons receiving broadcast content use; and the content provider terminals 5 are terminals that persons providing content use.

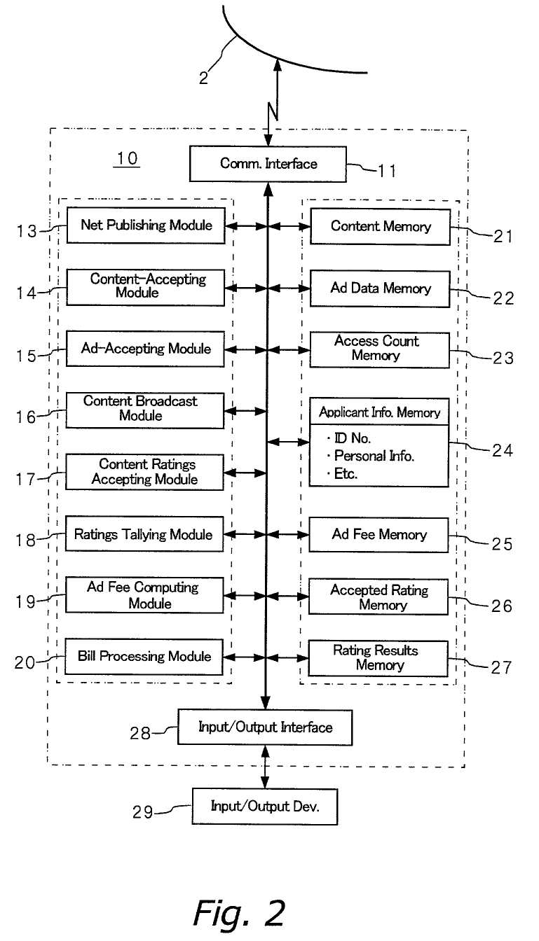

As shown in FIG. 2, the central processing device 10 is provided with: network publishing module (“Net publishing module” hereinafter) 13 composed of a CPU, ROM, RAM, and program-storing units; content-accepting module 14; ad-accepting module 15; content broadcast module 16; content rating accepting module 17; ratings tallying module 18; ad fee computing module 19; and bill processing module 20; and also content memory 21, composed of auxiliary storage devices such as hard disks; ad data memory 22; access count memory 23; applicant information memory 24; ad fee memory 25; accepted rating memory 26; and rating result memory 27; as well as communications interface 11, input/output interface 28, and input/output device 29. Via the communications interface 11, the central processing device 10 is connected to the network 2. Details of the modules are explained below.

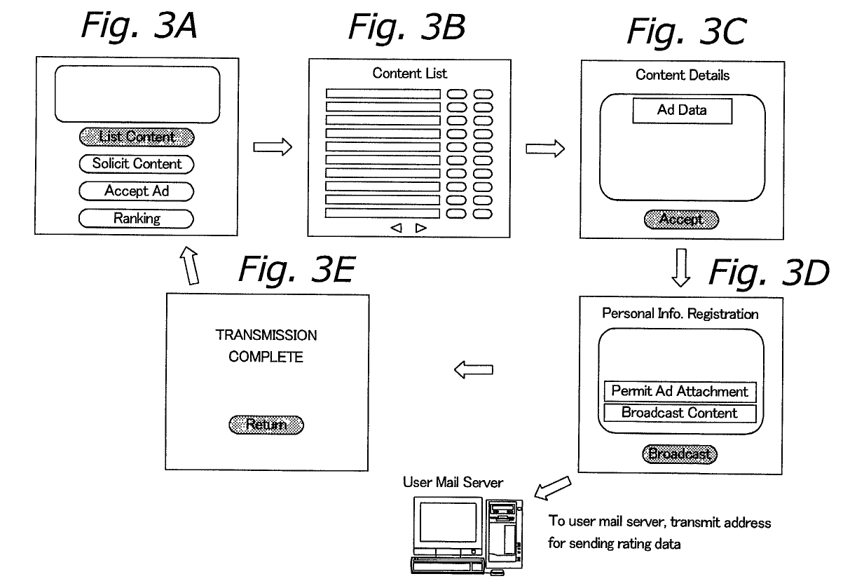

The Net publishing module 13 is a processing module that by means of the Web Pages depicted in FIG. 3 through FIG. 7 publishes, via the network 2, text, voice, and image information/data (novels, essays, music, movies, photographs, pictures, designs, educational information); proprietary content on computers/software (such as game programs); and information concerning content solicitations and receipt of advertising. The above-noted Web pages can be browsed through the advertising provider terminals 3, the user terminals 4, and the content provider terminals 5, via the network 2. Therein, a process is carried out to count how many times the above-noted Web Pages are accessed through the user terminals 4, and to store the tallied access count in the access count memory 23.

The content-accepting module 14 accepts content transmitted, or in other words uploaded, from content provider terminals 5 that have accessed the above-noted Web Pages, and carries out a process to store data on the accepted content in the content memory 21. The ad-accepting module 15 accepts transmissions of advertising data (applications for advertisements) from advertising provider terminals 3 that have accessed the above-noted Web Pages, and carries out a process to store the accepted advertising data in the ad data memory 22. Here, when accepting advertising data, the ad-accepting module 15 accepts the advertising data together with information on content that is to be attached when the advertising data being accepted is broadcast. Correlating the advertising data with the content information as such, the ad-accepting module 15 stores it in the ad data memory 22.

The content broadcast module 16, in response to requests from user terminals 4 that have accessed the above-noted Web Pages, broadcasts content stored in the content memory 21 together with advertising data that is to be attached to the given content, to the user terminals 4 having requests. At the same time, it counts the number of times each content item is broadcast, and carries out a process that stores in the access count memory 23 the per-content broadcast count tallied. Further, in accepting broadcasts the content broadcast module 16 accepts personal information on broadcast applicants (users) and carries out a process that stores the accepted personal information in the applicant information memory 24. Herein, when content is broadcast, users may refuse attachment of advertising data; in this case, as will be described later, the bill processing module 20 bills these users a special content broadcast fee.

Again, the content rating accepting module 17 accepts ratings on content from user terminals 4 to which content has been broadcast, and carries out a process that stores accepted rating information in the accepted rating memory 26. The ratings tallying module 18 ranks the content items based on the access count stored in the access count memory 23, the broadcast count, and the rating information stored in the accepted rating memory 26, and carries out a process that stores the obtained ranking data in the rating result memory 27.

Again, the ad fee computing module 19 computes an attachment fee, i.e. an advertising fee, for attaching advertising data when content is broadcast, based on the per-item content access count stored in the access count memory 23, the broadcast count, and the ranking data stored in the rating result memory 27, and carries out a process that stores computed advertising fee data in the ad fee memory 25. Computation of the advertising fee is performed on the basis of at least one criterion selected from the access count, the broadcast count, and the ranking data; the advertising fee may be reckoned rating these comprehensively. For example, the fees can be established proportionately so that if the access count and the broadcast count are made the criteria, the advertising fees will be higher as the counts are larger, or so that if the ranking data is made the criterion, the advertising fees will be higher as the ranking is higher. Also, the advertising fees are herein computed periodically, on the basis of which the data stored in the ad fee memory 25 is periodically updated.

Further, the bill processing module 20 carries out a billing process in response to information input in instances of broadcast content requests made from user terminals 4 that have accessed the above-noted Web Pages, and information input in instances of applications for advertisements made from the advertising provider terminals 3. It should be understood that the billing method might be a method in which credit is used.

To be specific, if a content broadcast request from a user terminal 4 is made and input refusing attachment of advertising data along with the requests has been made, the bill processing module 20 carries out a process that charges the given broadcast requester a content broadcast fee. Also, the content broadcast fee can be determined according to an accepted desired sum when content has been accepted by the content-accepting module 14, by accepting the desired sum from the provider of the given content.

Further, wherein an application for advertisement has been made from an advertising provider terminal 3, based on content for which advertising attachment is desired, the bill processing module 20 carries out a process that retrieves advertising fees per content item stored in the ad fee memory 25, reads out a given advertising fee, and charges the advertising provider that made the application the read-out advertising fee. It should be noted that after an application is accepted the advertising fees are charged periodically, and in those instances, updated advertising fees are charged.

Further detailed process content for the above-described processing modules will be explained below based on FIG. 3 through FIG. 7.

A. Content Display and Broadcast

First display and broadcast of content will be explained with based on FIG. 3. Initially the previously noted Net publishing module 13 publishes the Home Page shown in FIG. 3A on network 2. The Home Page is for publishing content information stored in the content memory 21, as well as information regarding receipt of content and advertising data. Accesses to the Home Page are then made through the advertising provider terminals 3, the user terminals 4, and the content provider terminals 5. When for example a list content button is clicked, the Net publishing module 13, as shown in FIG. 3B, forwards list screens by genre-music, novels, game programs-to the terminal devices 3, 4, 5 through which there has been access. Herein, the list screens are prepared from data stored in the content memory 21.

When the display column regarding the content items for the list screen shown in FIG. 3B is clicked, next the Net publishing module 13, as shown in FIG. 3C, displays on the terminal devices 3, 4, 5 a screen expressing detailed information on the given content. This enables users thus to make a judgment readily as to whether or not broadcast of the given content should be received. Therein, also, advertising data stored in the ad data memory 22, corresponding to the given content, is displayed in the display column. Further, a count of access to the detailed information is tallied, per content item, and the tallied access count is stored in the access count memory 23.

Next, when the accept button on the display screen shown in FIG. 3C is clicked by a user who has confirmed detailed content information, by which there is a broadcast request for the given content from the given user terminal 4, the Net publishing module 13 displays on the given user terminal 4 the registration screen shown in FIG. 3D. Then, when personal information (name, age, sex, e-mail address, etc.) from the given user is input, the information is accepted from the content broadcast module 16, and is stored in the applicant information memory 24. By actuating an advertising attachment permit/deny button, when content is broadcast a given user can select whether or not to refuse attachment of advertising data; wherein attachment of advertising data is refused, a broadcast fee for the given content is displayed on the screen.

Then if after personal information registration the broadcast button on the display screen is clicked, the Net publishing module 13 sends a broadcast command to the content broadcast module 16, and meanwhile Web Page address data for transmitting rating data is transmitted to the e-mail address registered as noted above.

Next, the content broadcast module 16 having received a broadcast command reads the ordered content out from the content memory 21, and at the same time reads out advertising data corresponding to the content, and after transmitting these to the given user terminal 4, sends “transmission complete” to the Net publishing module 13. Then the Net publishing module 13 displays the transmission complete screen shown in FIG. 3E on the given user terminal 4, and the transmission process ends. Now, advertising data broadcast together with content will thus be displayed together with it when the content is displayed on the display device for the user terminal 4. Further, wherein attachment of advertising data has been refused, a billing process is done by the bill processing module 20.

B. Content Rating and Display

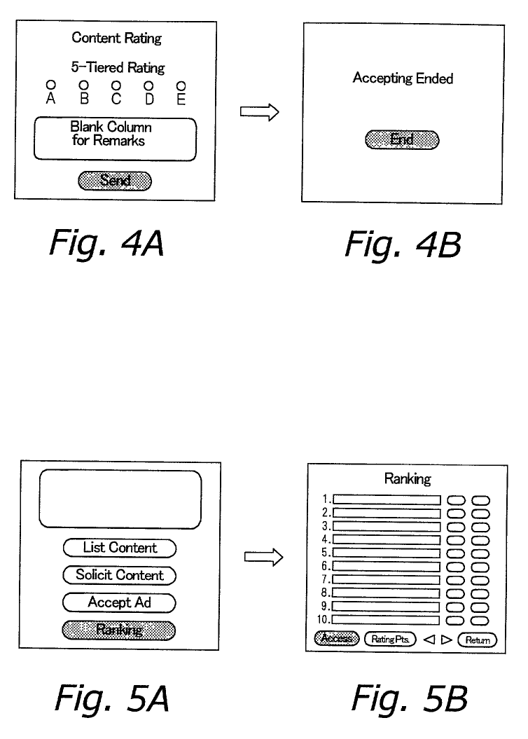

Next, post-broadcast rating of content will be explained according to FIG. 4. Initially, when from the given user terminal 4 the address for transmitting rating data, transmitted as noted above to the user's e-mail address, is accessed the Net publishing module 13 displays on the given user terminal 4 an rating input screen as shown in FIG. 4A. Then, following along with the input screen when there is rating input on broadcast content from the given user, it is accepted by the content rating accepting module 17, and the accepted rating data is stored in the accepted rating memory 26. After thus accepting the rating data, the Net publishing module 13 displays on the user terminal 4 the accepting ended screen shown in FIG. 4B, and the given rating accepting process ends.

Then, the ratings tallying module 18 as described above periodically tallies the rating data accumulated in the accepted rating memory 26 as well as the data stored in the access count memory 23, carries out a process that genre by genre assigns rank to the content, and stores the results of this process in the rating result memory 27. Also, the process results stored in the rating result memory 27 are updated by the ratings tallying module 18 every time the process is carried out.

Accordingly, the results rated by the ratings tallying module 18 are displayed by means of screens as shown in FIG. 5A and 5B. That is, when a ranking button on a Home Page (FIG. 5A) published by the above-noted Net publishing module 13 is clicked, the display screen shown in FIG. 5B is forwarded from the Net publishing module 13 to the terminal devices 3, 4, 5 that have accessed the Home Page; and the ranking based on the access count and the broadcast count, as well as the ranking based on the accepted rating data, which are stored in the rating result memory 27, are displayed. Thus when contracting for advertising, as will be described later, advertising providers (sponsors) can thereby select content for which advertising effectiveness is high, which enables effective advertising to be carried out.

C. Receipt of Advertising

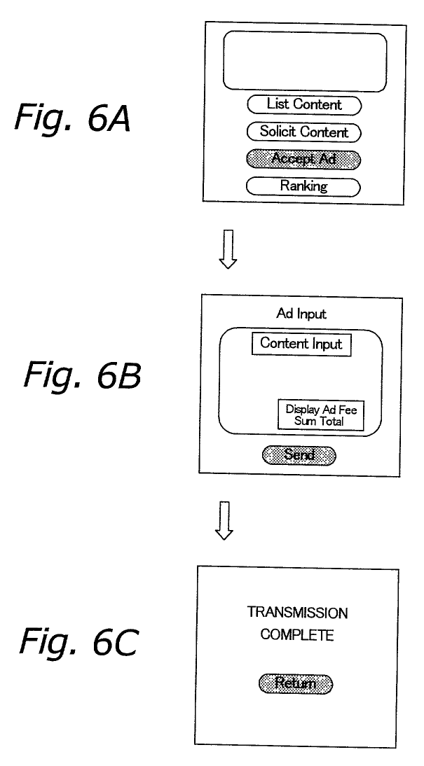

Initially, when an accept advertising button on the screen is clicked by an advertising provider terminal 3 that has accessed the above-noted Home Page (FIG. 6A), the Net publishing module 13 displays on the given advertising provider terminal 3 the advertising data input screen as shown in FIG. 6B. Then, when advertising data is input through an advertising provider following along the above-noted advertising data input screen, the data is accepted by the ad-accepting module 15 and stored in the ad data memory 22. Therein, in broadcasting content, content information to which given advertising data is to be attached is input at the same time, and advertising data correlated with the given content information is stored in the ad data memory 22. Further, when content information is input, the billing process module 20, based on the given content information, retrieves advertising fees per content item stored in the ad fee memory 25, reads out the applicable advertising fee, and displays the read-out advertising fee on the given advertising provider terminal 3, meanwhile charging the given advertising provider the advertising fee. It should be noted that billing is carried out periodically after accepting an application, and in those instances, updated advertising fees are charged.

As described above, since advertising providers can check content rankings via the ranking display screens, the advertising providers can, for example, select content items to which their own advertising data is attached-items in a range from that for which the access count is largest, sequentially to a predetermined ordinal number. Moreover, content for which future access counts and broadcast counts are anticipated to increase may be selected from the rating results. Thus being able to make this selection enables the advertising providers to carry out advertising most effectively.

Then after the accept advertising process as noted above has ended, the Net publishing module 13 displays on the advertising provider terminal 3 a “transmission complete” screen as shown in FIG. 6C.

D. Receipt of Content

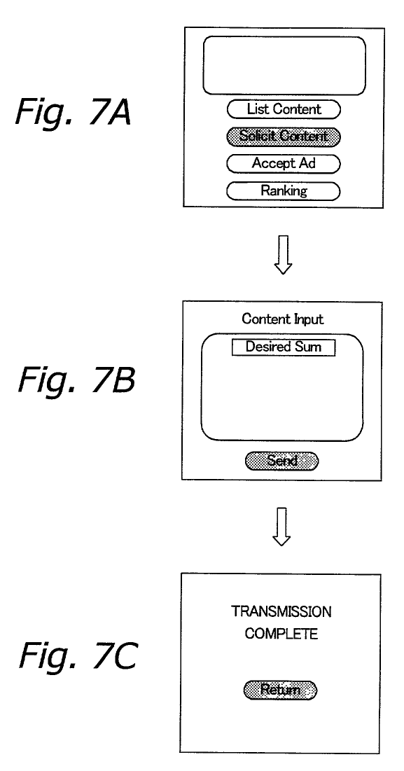

Initially, when a content subscription button on the screen is clicked by a content provider terminal 5 that has accessed the above-noted Home Page (FIG. 7A), the Net publishing module 13 displays on the given content provider terminal 5 the content input screen as shown in FIG. 7B. Then, when content data as input data or as attachment data is transmitted, i.e. uploaded, through a content provider following along the above-noted content input screen, the data is accepted by the content-accepting module 14 and stored in the content memory 21. Then after the accept content process as noted above has ended, a “transmission complete” screen as shown in FIG. 7C is displayed by the Net publishing module 13 on the content provider terminal 5. Through the FIG. 7B screen, the content provider can input a desired broadcast fee such that wherein content is broadcast without attachment of advertising, the desired broadcast fee that has been input will be stored together with the content information in the content memory 21. Thus based on the desired broadcast fee, the above-described billing process is done if attachment of advertising data is refused. This means, moreover, that the content providers separately receive remuneration in accordance with their content broadcast volume (i.e., amount).

As detailed in the foregoing, by means of a broadcast system 1 in the present example advertising data carried in content for broadcast and posted on Web Pages, or else broadcast together with content, is solicited via the network 2, and therefore the data can be gathered at low cost. This moreover makes it easy for content providers to provide content they created themselves.

Further, the advertising providers, by looking through the content information, the access counts and broadcast counts therefor, and the user-rated rating results can, upon checking this over, consider to which content items their advertising should be attached. The advertising providers therefore can advertise more effectively by, for example, considering users' age brackets assumed from the genre to which the content belongs; by selecting content items in a range from that for which the access count is largest, sequentially to a predetermined ordinal number; or further, by selecting from the rating results content for which future access counts and broadcast counts are anticipated to increase. Needless to say the present system enables the advertising providers to attach their advertising to all content that is broadcast.

### Second Embodiment

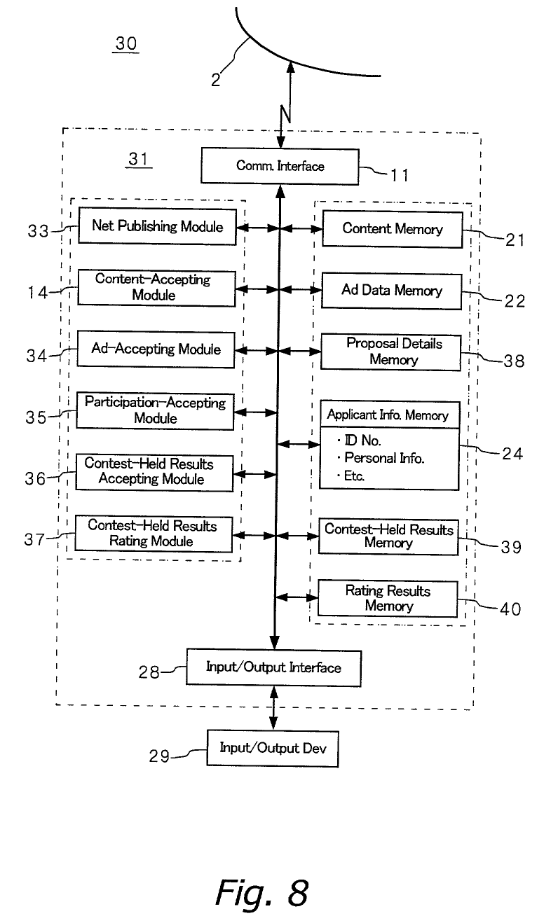

Next, a second embodiment of the present invention will be explained. FIG. 8 is a block diagram depicting a configurational outline of a central processing device that configures a contest execution system involving the present embodiment. The contest execution system 30 in the present example, likewise as with the above-described broadcast system 1 shown in FIG. 1, is provided inter alia with: advertising provider terminals 3 interconnected via a network 2 such as the Internet, user terminals 4, content provider terminals 5, and a central processing device 31. The central processing device 31 functions as an Internet server such as a WWW (World Wide Web) server, and as a server equipped with a CGI (Common Gateway Interface) script. The advertising provider terminals 3, the user terminals 4, and the content provider terminals 5 function as clients respectively furnished with browsers.

As shown in FIG. 8, the central processing device 31 in the present example is provided with: Net publishing module 33 composed of a CPU, ROM, RAM, and program-storing units; content-accepting module 14; ad-accepting module 34; participation-accepting module 35; contest-held results accepting module 36; and contest-held results rating module 37; and also content memory 21, composed of auxiliary storage devices such as hard disks; ad data memory 22; proposal details memory 38; applicant information memory 24; contest-held results memory 39; rating results memory 40; as well as communications interface 11, input/output interface 28, and input/output device 29. Via the communications interface 11, the central processing device 31 is connected to the network 2.

Insofar as the communications interface 11, the input/output interface 28, input/output device 29, content-accepting module 14, content memory 21, ad data memory 22, applicant information memory 24 are configured similarly to those of the central processing device 10 of the foregoing example, identical reference marks are ascribed to these sections of the configuration, and detailed explanation thereof is consequently omitted from the following.

The Net publishing module 33 performs, in addition to processes in connection with soliciting content and inviting advertisement in the Net publishing module 13 of the foregoing example, a process that publishes on the network 2 information regarding proposal details for contests stored in the proposal details memory 38. In specific terms, it publishes on the network 2 a Home Page as shown in FIG. 3A, prepares on the given Home Page click buttons enabling access to Web Pages on which detailed information on contests is posted, and carries out a process that allows the terminal devices 3, 4, 5 in which there has been access to peruse the Web Pages posted with the details.

A contest in the present example is a match that utilizes content stored in the content memory 21; for example, for a case in which content is a game program, it would mean a ranking competition based on points gained executing the game program. The proposal details of the relevant contest are established in advance and stored in the proposal details memory 38.

Further, a click button for applying to participate in a given contest is set up on the Web Page carrying the contest information put on view by the net publishing module 33; and when the click button is clicked, the Net publishing module 33 displays on the terminal devices 3, 4, 5 where there has been access the registration screen as shown in the above-mentioned FIG. 3D. Then, when personal information (name, age, sex, e-mail address, etc.) is input through the given terminal devices 3, 4, 5, it is accepted by the participation-accepting module 35; the accepted personal information is stored in the applicant information memory 24.

Then, when recording of personal information is complete, a content broadcast command is transmitted from the Net publishing module 13 to the participation-accepting module 35. The participation-accepting module 35 having received the broadcast command reads out content for the contest from the content memory 21, whereas it reads out from the ad data memory 22 advertising data to be attached to the content, and after transmitting these to the participation applicants' terminal devices 3, 4, 5, transmits a “transmission complete” to the Net publishing module 13. Then, the Net publishing module 13 displays on the participation applicants' terminal devices 3, 4, 5 a transmission complete screen as shown in FIG. 3E, and the transmission process ends. Here, the broadcasting of content is made such that the participation applicants can refuse attachment of advertising data; in that case, it is made such that the participation applicants are billed a separate content broadcast fee.

Here the advertising data stored in the ad data memory 22 has been accepted from the advertising provider terminals 3 by the ad-accepting module 34 and stored in the said ad data memory 22. Specifically, when an accept advertising button on a screen is clicked by an advertising provider terminal 3 that has accessed a Home Page as shown in FIG. 6A, published on the network 2 by the Net publishing module 33, the Net publishing module 33 displays on the given advertising provider terminal 3 an advertising data input screen as shown in FIG. 6B. Then, when advertising data is input and transmitted through the advertising provider following along the just-noted advertising data input screen, it is accepted by the ad-accepting module 34 and stored in the ad data memory 22. Receipt of advertising here means that a special advertising fee is charged.

Next, participants who in the above describe manner have received content broadcast for a contest execute the contest using their terminal devices 3, 4, 5. The outcome of the contest held (if the content is a game program, scores obtained by executing the game program) gets transmitted to the central processing device 31 via the Web Page displayed by the Net publishing module 33. The transmitted outcome is accepted by the contest-held results accepting module 36 and stored in the contest-held results memory 39.

The participants' contest-held results accumulated in the contest-held results memory 39 are tallied by the contest-held results rating module 37 after a predetermined period, an rating process that assigns participant rankings is performed, and the given rating results are stored in the rating results memory 40. Then, the rating results in this way stored in the rating results memory 40 are published by the Net publishing module 33 on the network 2.

As described in detail in the foregoing, by means of a contest execution system 30 in the present example, likewise as with the above-noted first embodiment, content broadcast for contests, and advertising data posted in Web Pages or else broadcast together with content, is solicited via a network, and therefore the data can be gathered at low cost. This moreover makes it easy for content providers to provide content they created themselves.

This moreover enables competitive matches to be set up by a technique heretofore completely non-existent that makes possible holding contests on the Net utilizing enlisted content. Again, the content providers are given the incentive that content they created is used in the contests, which succeeds in the effect that content the content providers create more enterprisingly themselves is provided. Also, because advertising data is broadcast together with content for contests to terminal devices 3, 4, 5 through which there have been applications to participate, advertising providers can carry out their advertising more effectively.

Here, in this example, the embodiment is made to configure the participation-accepting module 35 so as to count the number of participation applicants; and to configure the Net publishing module 33 so as to publish the participation applicant count reckoned by the participation-accepting module 35. Accordingly, the advertising providers can check counts of participants in the contests, and therefore the advertising providers can readily predict the effectiveness of advertisement postings by way of the contests, enabling them readily to perform judgments as to whether advertising should be posted. Moreover, the content providers herein receive remuneration in accordance with their content broadcast volume.

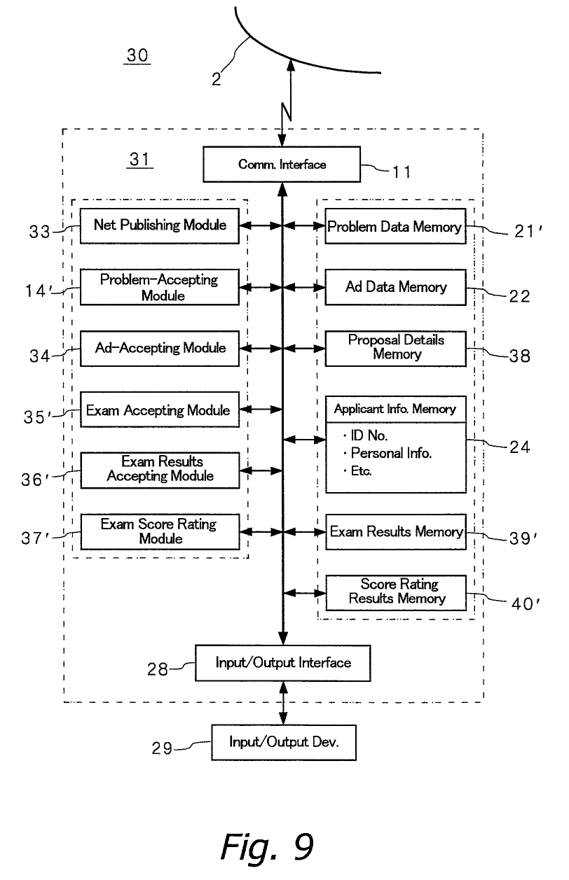

Also, depending on the type and character of the content, various sorts of the foregoing competitive matches, other than the above-described game tournaments can be set up. As one example thereof, an instance in which the competitive match is a public practice (mock/simulation) exam is illustrated in FIG. 9. The content herein is exam problems. Accordingly, in FIG. 9 the foregoing content-accepting module 14 is denoted as problem-accepting module 14′, and the content memory 21 is denoted as problem data memory 21′. Further, the participation-accepting module 35 is denoted as an exam accepting module 35′; the contest-held results accepting module 36 is denoted as an exam results accepting module 36′; the contest-held results rating module 37 is denoted as a (exam) score rating module 37′; the contest-held results memory 39 is denoted as an exam results memory 39′; and the rating results memory 40 is denoted as a score rating results memory 40′.

In this example, via the network 2 exam problems are publicly advertised for, and a mock exam is held using the exam problems thereby committed. The exam problems are transmitted to the test-taker user terminals 4, and in making the transmission, advertising data from advertising providers is also transmitted. The exam results are accepted from the test-takers by the exam results accepting module 36′, and the score rating module 37′ grades the exams and makes ratings by rankings and percentiles.

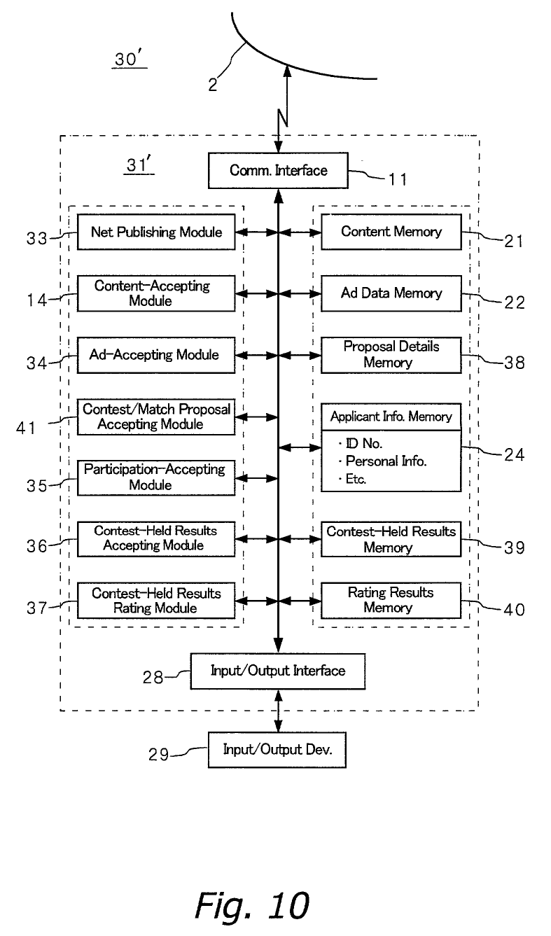

As described above, the subject matter of the foregoing competitive match is set up beforehand, but as shown in FIG. 10, by furnishing a contest/match proposal accepting module 41, proposed material for contests may be invited via the network 2 from the public at large including content providers, advertising providers, contest participants. Doing so yields the benefit for the content providers of establishing contests in which content concepts they themselves intended are sufficiently put to use. Furthermore, it yields the benefit for the advertising providers of being able to advertise more effectively, by setting up contests that can rally participants focussed into customer strata the advertising providers target.

The foregoing has explained embodiments of the present invention, but needless to say the specific forms into which the present invention may be adopted are not limited to these. For example, in the described embodiments the above-mentioned advertising data is posted on a screen carrying detailed content information, and broadcast together with broadcast content; but embodiments of the invention are not thus limited, and for instance may be such that the data is posted on a Home Page as shown in FIG. 3A.

What is claimed is:

1. A content broadcasting system being connected via a network to a central processing device and a plurality of terminal devices, the content broadcasting system configured for broadcasting content from the central processing device to the terminal devices, and characterized in that the central processing device is configured by comprising:
a content-accepting module for accepting offers of content from the terminal devices;
a content memory for storing accepted content;
an ad-accepting module for accepting advertising data from the terminal devices;
an ad data memory for storing advertising data accepted by said ad-accepting module;
a network publishing module for publishing information related to the content stored in said content memory, together with advertising data stored in said ad data memory; and
a content broadcast module for accepting content broadcast requests from the terminal devices and broadcasting requested content to the terminal devices where there have been broadcast requests.

2. A content broadcasting system as set forth in claim 1, further provided with a broadcast fee billing module established so as to charge broadcast requesters a pre-set broadcast fee wherein said content broadcast module has broadcast content to the terminal devices where there have been broadcast requests.

3. A content broadcasting system being connected via a network to a central processing device and a plurality of terminal devices, the content broadcasting system configured for broadcasting content from the central processing device to the terminal devices, and characterized in that the central processing device is configured by comprising:
a content-accepting module for accepting offers of content from the terminal devices;
a content memory for storing accepted content;
a network publishing module for publishing information related to the content stored in said content memory;
an ad-accepting module for, in broadcasting the content, accepting from the terminal devices advertising data to be attached to content that is broadcast;
an ad data memory for storing correlatively with corresponding content, advertising data accepted by said ad-accepting module;
a content broadcast module for accepting content broadcast requests from the terminal devices and broadcasting to the terminal devices where there have been broadcast requests requested content together with the advertising data to be attached to content.

4. A content broadcasting system as set forth in claim 3, wherein said content broadcast module is configured so as, in response to requests from the terminal devices, to attach advertising selectively to and broadcast content to the terminal devices where there have been broadcast requests.

5. A content broadcasting system as set forth in claim 4, being further provided with a broadcast fee billing module established so as to charge broadcast requesters a pre-set broadcast fee wherein said content broadcast module has broadcast content without attaching advertising data, to the terminal devices where there have been broadcast requests.

6. A content broadcasting system as set forth in claim 3, wherein said network publishing module is:
configured to publish overview information relating to content stored in said content memory, and meanwhile to broadcast in response to requests from the terminal devices detailed information relating to content stored in said content memory; at the same time
configured to count per content item number of times detailed information on content items has been accessed through the terminal devices; and further
configured to publish the access count together with the overview information.

7. A content broadcasting system as set forth in claim 6, being further provided with an ad fee computing module for computing based on the access count counted by said network publishing module an advertising fee varying according to what number the access count is.

8. A content broadcasting system as set forth in claim 7, being further provided with an ad fee billing process module for charging advertising applicants advertising fees computed by said ad fee computing module.

9. A content broadcasting system as set forth in claim 3, wherein said content broadcast module is configured so as to count the number of times each content item is broadcast to the terminal devices; and wherein said network publishing module is configured so as to publish the broadcast count counted by said content broadcast module.

10. A content broadcasting system as set forth in claim 9, being further provided with an ad fee computing module for computing based on the broadcast count counted by said content broadcast module an advertising fee varying according to what number the broadcast count is.

11. A content broadcasting system as set forth in claim 10, being further provided with an ad fee billing process module for charging advertising applicants advertising fees computed by said ad fee computing module.

12. A content broadcasting system as set forth in claim 3, further provided with a content rating module for accepting rating information relating to content received from the terminal devices having received broadcast of content, and carrying out a content rating process on each content item by tallying the accepted rating information; wherein said network publishing module is configured so as to publish results of ratings by said content rating module.

13. A content broadcasting system as set forth in claim 12, being further provided with an ad fee computing module for computing based on the results of ratings by said content rating module advertising fees varying according to rating results.

14. A content broadcasting system as set forth in claim 13, being further provided with an ad fee billing process module for charging advertising applicants advertising fees computed by said ad fee computing module.

15. A contest execution system being connected via a network to a central processing device and a plurality of terminal devices, the contest execution system configured for broadcasting content from the central processing device to the terminal devices and configured so as to set up contests utilizing the content in the central processing device, and characterized in that the central processing device is configured by comprising:
a content-accepting module for accepting offers of content from the terminal devices;
a content memory for storing accepted content;
an ad-accepting module for accepting advertising data from the terminal devices;
an ad data memory for storing advertising data accepted by said ad-accepting module;
a network publishing module for publishing, together with advertising data stored in said ad data memory, contest proposal material utilizing the content stored in said content memory;
a participation-accepting module for accepting applications from the terminal devices to participate in contests, and broadcasting content to terminal devices where there have been applications;
a contest-held results accepting module for accepting from the terminal devices results of contests executed utilizing the content; and
a contest-tallying module for tallying contest-held results accepted by said contest-held results accepting module and thereby assigning contest participant rankings.

16. A contest execution system as set forth in claim 15, wherein said participation-accepting module is established so as to broadcast together with the content advertising data stored in said ad data memory, to terminal devices where there have been participation applications.

17. A contest execution system as set forth in claim 15, wherein said participation-accepting module is configured so as to count participation applicant number; and wherein said network publishing module is configured so as to publish the participation applicant count counted by said participation-accepting module.

18. A contest execution system as set forth in claim 15, further provided with proposal accepting module for accepting from the terminal devices contest proposals utilizing content stored in said content memory; the network publishing module being configured so as to publish proposal material accepted by the proposal accepting module, together with the advertising data stored in said ad data memory.

19. A contest execution system being connected via a network to a central processing device and a plurality of terminal devices, the contest execution system configured for broadcasting content from the central processing device to the terminal devices and configured so as to set up contests utilizing the content in the central processing device, and characterized in that the central processing device is configured by comprising:
a content-accepting module for accepting offers of content from the terminal devices;
a content memory for storing accepted content;
an ad-accepting module for accepting advertising data from the terminal devices;
an ad data memory for storing advertising data accepted by said ad-accepting module;
a network publishing module for publishing contest proposal material utilizing the content stored in said content memory;
a participation-accepting module for accepting applications from the terminal devices to participate in contests, and broadcasting the content to terminal devices where there have been applications, together with advertising data stored in said ad data memory;
a contest-held results accepting module for accepting from the terminal devices results of contests executed utilizing the content; and
a contest-tallying module for tallying contest-held results accepted by said contest-held results accepting module and thereby assigning contest participant rankings.

20. A contest execution system as set forth in claim 19, wherein said participation-accepting module is configured so as to count participation applicant number; and wherein said network publishing module is configured so as to publish the participation applicant count counted by said participation-accepting module.

21. A contest execution system as set forth in claim 19, further provided with proposal accepting module for accepting from the terminal devices contest proposals utilizing content stored in said content memory; the network publishing module being configured so as to publish proposal material accepted by the proposal accepting module, together with the advertising data stored in said ad data memory.
